(19) United States
(12) Patent Application Publication
(10) Pub. No.: US 2015/0351988 A1
(43) Pub. Date: Dec. 10, 2015

(54) STANDING PLATFORM

(71) Applicants: Ryan Feeley, Cupertino, CA (US); Christopher Perkins, Cupertino, CA (US)

(72) Inventors: Ryan Feeley, Cupertino, CA (US); Christopher Perkins, Cupertino, CA (US)

(21) Appl. No.: 14/732,651

(22) Filed: Jun. 5, 2015

Related U.S. Application Data
(60) Provisional application No. 62/009,141, filed on Jun. 6, 2014.

(51) Int. Cl. A61H 1/00

(52) U.S. Cl. CPC A61H 1/003

(57) ABSTRACT

An apparatus includes a platform and an actuator. The platform includes a first platform region with a first surface, and a second platform region with a second surface. The actuator is operatively coupled with the first platform region and with the second platform region, and moves the apparatus between a first and a second state. At the first state, the first surface defines a first orientation, and the second surface defines a second orientation, where the first and second orientations are substantially symmetric and the first and second surfaces are substantially at the same height as one another. At the second state, the first surface defines a third orientation, and the second surface defines the second orientation, where the third orientation is not symmetric with the second orientation. The availability of more than one platform configuration encourages a user standing on the platform to assume varied standing postures.

### CROSS-REFERENCES TO RELATED APPLICATIONS

This application claims the benefit of U.S. Provisional Application No. 62/009,141, filed on Jun. 6, 2014, the entirety of which is incorporated by reference herein.

### BACKGROUND OF THE INVENTION

Many people, such as cashiers, factory workers, and teachers, must remain standing in a substantially stationary position for prolonged periods while at work. In addition, many workers in traditional office environments are choosing to stand for various health reasons. Recent research has shown that sitting in a traditional office chair for eight hours a day, five days a week, does irreversible damage that cannot be counteracted by any amount of exercise in the remaining hours. See http://aje.oxfordjournals.org/content/172/4/419.abstract (attached hereto as Appendix C, and incorporated herein by reference) and http://chriskresser.com/how-sitting-too-much-is-making-us-sick-and-fat-and-what-to-do-about-it (attached hereto as Appendix D, and incorporated herein by reference). Notably, as discussed in the latter, a large study involving over 100,000 U.S. adults found that those who sat for more than six hours a day had up to a 40 percent greater risk of death over the next 15 years than those who sat for less than three hours a day. This effect occurred regardless of whether the participants exercised.

Standing rather than sitting for prolonged periods provides numerous health benefits, such as:
Reduced Obesity Risk
Reduced Risk of Type II Diabetes and other Metabolic Conditions
Reduced Risk of Cardiovascular Disease
Reduced Risk of Cancer
Lower Long-Term Mortality
   See http://www.smithsonianmag.com/science-nature/five-health-benefits-standing-desks-180950259/?no-ist (attached hereto as Appendix E, and incorporated herein by reference).

However, if one is locked in to, e.g., a computer keyboard, he or she typically must stand very still. Furthermore, a worker that is extremely focused may also find him- or herself standing very still. Standing in one single position for a prolonged period can also lead to health problems, such as:
Decreased circulation
Pooling of blood and extracellular fluid in the legs
Decreased respiration
Decreased productivity
Damage to retrograde flow valves in the veins of the legs
Increased likelihood of varicose veins
Increased joint, muscle, and connective tissue pain and tightness as compared to people who are moving (not sitting or standing still).

Fatigue and fidgetiness are currently the only feedback mechanisms that standing workers might experience to prompt them to move around. A product is needed that will prompt slight movements, without the need to leave one's desk, to prevent fatigue before it sets in.

### SUMMARY

An apparatus includes a platform and an actuator. The platform includes a first platform region with a first surface, and a second platform region with a second surface. The actuator is operatively coupled with the first platform region and with the second platform region, and moves the apparatus between a first and a second state. At the first state, the first surface defines a first orientation, and the second surface defines a second orientation, where the first and second orientations are substantially symmetric and the first and second surfaces are substantially at the same height as one another. At the second state, the first surface defines a third orientation, and the second surface defines the second orientation, where the third orientation is not symmetric with the second orientation.

The actuator may move the apparatus between the first state, the second state, and a third state at which the first surface defines the first orientation and the second surface defines a fourth orientation, where the fourth orientation is not symmetric with the first orientation.

The first and second surfaces may each be substantially planar, or at least one of the first surface and the second surface may differ substantially from planarity.

The first and the second orientations may each be substantially horizontal, or at least one of the first orientation and the second orientation may differ substantially from horizontal.

The first platform region may be a first step configured and dimensioned for at least a portion of a first foot of a user to rest thereon, and the second platform region may be a second step configured and dimensioned for at least a portion of a second foot of the user to rest thereon. The first platform region may be a first step configured and dimensioned for an entirety of the first foot of the user to rest thereon, and the second platform region may be a second step configured and dimensioned for an entirety of the second foot of the user to rest thereon.

The platform may further include a third platform region, where each of the first platform region and the second platform region is hingedly connected to the third platform region. The third platform region may remain substantially stationary at a fifth orientation, in both the first state and the second state. The fifth orientation may be substantially horizontal and substantially co-planar with the first orientation and the second orientation.

The apparatus may be configured and dimensioned to be stowed underneath a standard office chair. The platform may include cut-outs configured and dimensioned to accommodate the wheels of the office chair. The platform may include a depression or a hole configured and dimensioned to accommodate the central hydraulic post at the bottom of the office chair.

The actuator may be exactly one actuator.

The actuator may include an arm that is configured to pivot to thereby lift the first platform region from the first orientation to the third orientation and to lift the second platform region from the second orientation to the fourth orientation.

The motion between the first state and the second state may prompt the user to move at least one foot, and/or to shift the user's weight.

Another embodiment of an apparatus includes a platform and an actuator. The platform includES a first platform region with a first surface and a second surface, and a second platform region with a third surface and a fourth surface. The first platform region and the second platform region are adjacent one another along medial regions thereof. The first surface and the third surface are substantially symmetric and substantially at the same height as one another, the second surface is not symmetric with the third surface, and the fourth surface is not symmetric with the first surface. The actuator is operatively coupled with the first platform region and with the second platform region and moves the apparatus between a first state and a second state. At the first state, the first surface and the third surface are adjacent one another along medial regions thereof. At the second state, at least a portion of the second surface is adjacent the third surface, to thereby define a first discontinuity between the medial regions of the first platform region and the second platform region.

The actuator may move the apparatus between the first state, the second state, and a third state at which at least a portion of the fourth surface is adjacent the first surface, to thereby define a second discontinuity between the medial regions of the first platform region and the second platform region.

The first, second, third, and fourth surfaces may each be substantially planar, or at least one of the surfaces may differ substantially from planarity.

### BRIEF DESCRIPTION OF THE DRAWINGS

FIG. 1A is a perspective view of a first exemplary apparatus, in the home position.

FIG. 1B illustrates the apparatus of FIG. 1A in the left step up position.

FIG. 2 is a plan view of the apparatus of FIGS. 1A and 1B, schematically illustrating a user's feet.

FIG. 3 is a bottom plan view of the underside of the apparatus of FIGS. 1A-2, with the base layer removed for clarity.

FIGS. 4A and 4B are detail perspective views of the apparatus of FIGS. 1A-3, in the home and left step up positions, respectively, with the cushioning layer and the actuator housing removed for clarity.

FIG. 5 is a detail perspective view of a lift arm and position-sensing hardware of the apparatus of FIGS. 1A-4B.

FIGS. 6A-6B are front elevation views of the lift arm and position-sensing hardware as seen in FIG. 5, in combination with the actuator, with the lift arm in two different orientations.

FIG. 7 is similar to FIG. 4B, but illustrates the mechanical stops in detail.

FIG. 8 is a detail view of an actuator housing and lift cantilevers for use in the apparatus of FIGS. 1A-4B and 7.

FIG. 9 is a top view of the actuator and lift cantilevers of FIG. 8, with the actuator housing removed for clarity.

FIG. 10A is a perspective view of a second exemplary apparatus, in the home position.

FIG. 10B illustrates the apparatus of FIG. 10A in the left step back position.

### DETAILED DESCRIPTION OF THE INVENTION

Exemplary embodiments described herein provide methods and apparatuses for preventing fatigue of a standing user, by prompting the user to move his or her feet intermittently, before fatigue or restlessness prompts him or her to do so. Users can now enjoy the benefits of standing without the drawbacks of prolonged standing in a single position, while still maintaining a tight window of interaction with their desks.

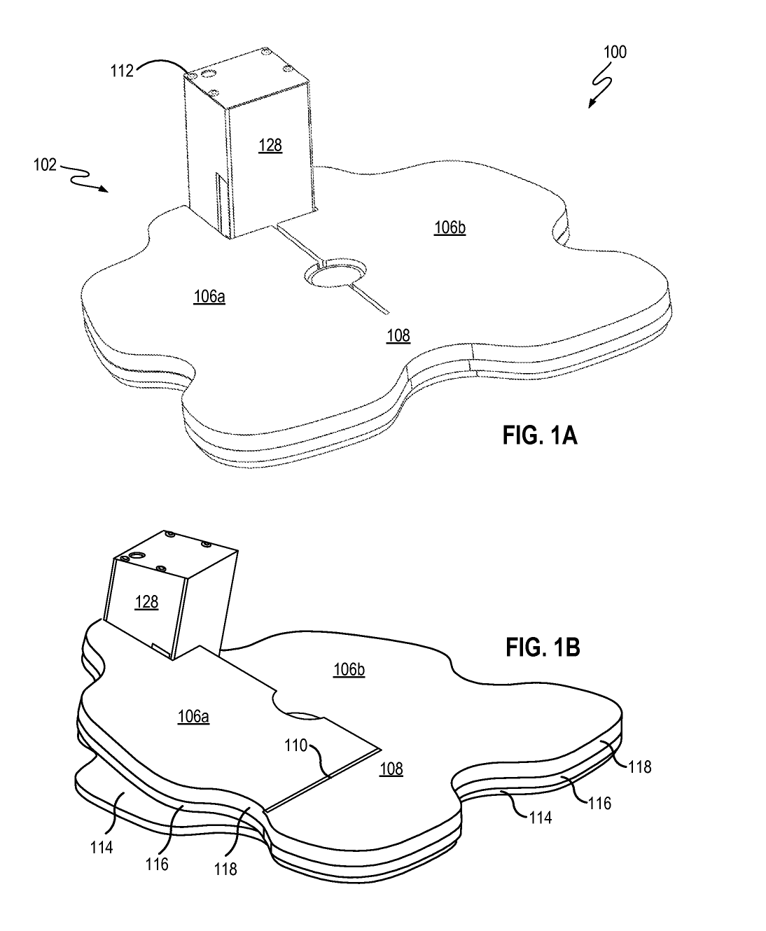

A first exemplary embodiment of an apparatus for preventing fatigue, hereinafter referred to as a “hinged” embodiment, or “pivoting” embodiment, is illustrated in FIGS. 1A-9. This embodiment includes a three-part platform 102, with the various components hingedly coupled to one another as will be described below.

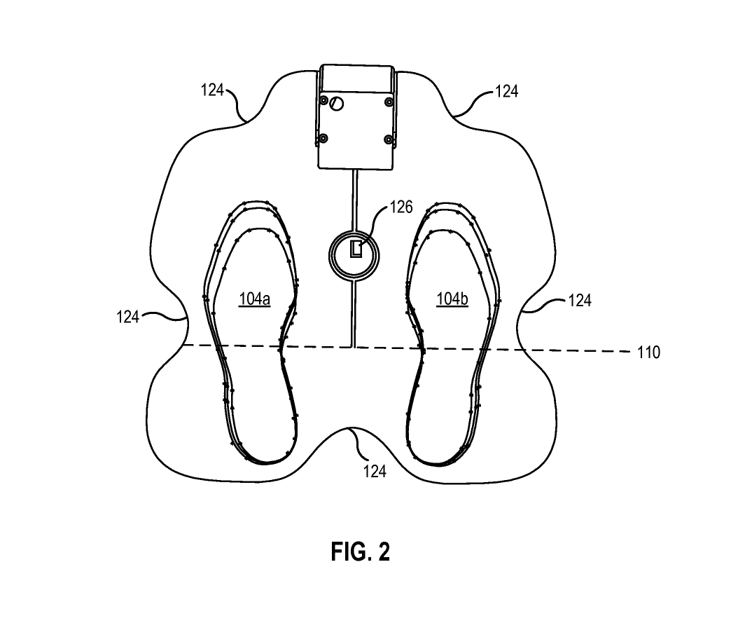

Turning first to FIG. 1A, when the apparatus 100 is in its home position, it presents a substantially flat horizontal standing platform 102, on which a user stands, such as in the position schematically illustrated by footprints 104a, 104b in FIG. 2. The user simply stands on the platform 102 in any comfortable position, such as with his or her weight equally distributed on both feet. The platform includes a left step 106a, right step 106b, and rear region 108, which, in the home position, cooperate to define a single planar surface, as seen in FIG. 1A.

The differently sized footprints in FIG. 2 indicate different shoe sizes. With the presently preferred dimensions of the apparatus, the largest illustrated footprints 104a, 104b indicate a men's size 14 shoe (US sizing).

After a set period of time, the apparatus 100 automatically pivots the left step 106a upward, as is seen in FIG. 1B. The right step 106b and rear region 108 remain substantially horizontal. If the user is standing in a neutral position, as is seen in FIG. 2, the hinge line 110, around which the left step 106a pivots, runs approximately through the center of the user's left foot 104a. Therefore, this automatic pivoting motion physically moves the user's left foot upwards, prompting the user to shift his or her weight. Typically, the user will move the left foot forward by several inches and bend the left knee slightly, putting the majority of the user's weight on the right foot.

After a set period of time, the left step 106a automatically pivots back down to the home position seen in FIG. 1A, which may prompt the user to move the left foot back and/or transfer some of his or her weight back to the left foot. After another set period of time, the process is repeated with the right step.

The inventors have also contemplated that the “pivoting” embodiment may be used rotated 180°, so that the user's heel region, rather than toe region, is raised and lowered by the steps 106a, 106b and the user's toe region rests on the “rear” region (now the front region) 108. Such motion can encourage flexing of the calf muscles, which helps expel pooled blood and reduce fatigue.

In some embodiments, each position (home, left step up, home, right step up, repeat) is held for approximately 30 seconds to approximately 90 seconds. In a presently preferred embodiment, each iteration of the home position is held for 90 seconds, and each iteration of a step up position is held for 30 seconds. Each step may pivot approximately 14 degrees, taking approximately 2 seconds to make the transition from home position to fully tilted, and from fully tilted to home. The claimed invention is not limited to any specific times or angles, which may vary based on individual needs and/or personal preference. In some embodiments, the time and/or angles may be user-settable. Additionally or alternatively, the time and/or angles may be pre-programmed.

To use the apparatus 100, a user must simply step onto the platform 102 and actuate the on button 112. In a presently preferred embodiment, the apparatus 100 is equipped with automatic shutoff. If resistance under a certain threshold is detected for several cycles in a row (indicating little or no weight resting on the platform 102), the apparatus 100 will automatically turn itself off Additionally or alternatively, the user may switch the apparatus 100 off, such as by depressing the on button 112 (or rather, in this embodiment, the on/off button 112) again.

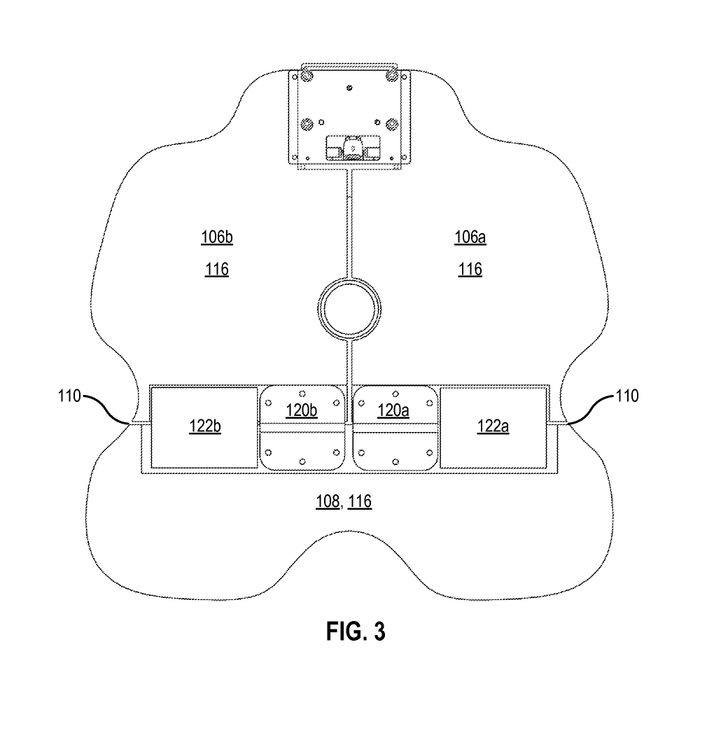

The three main layers of the platform 102 are a one-part stationary base 114, three-part intermediate layer 116, and one-part cushioning layer 118, as illustrated. Referring to FIG. 3 (which illustrates the apparatus 100 from underneath, with the base 114 removed, to show the underside of the intermediate layer 116), hinges 120a, 120b, 122a, 122b are attached to the underside of the intermediate layer 116 and attach each step 106a, 106b to the rear region 108. In the presently preferred embodiment, substantially the entire length of the seam between each step 106a, 106b and the rear region 108 is supported by hinges, as illustrated. In the illustrated embodiment, each step 106a, 106b is attached to the rear region 108 by two separate hinges: one pinned hinge 120a, 120b (of the type commonly used on household doors and cabinets), and one flex hinge 122a, 122b. The flex hinges 122a, 122b are essentially flat sheets of, e.g. polymeric material, such as plastic, fastened across the hinge line 110. The flex hinges differ from conventional, pinned hinges in that they have no “slop,” and they provide stiffness in resistance to bending. The combination of the pinned hinges 120a, 120b and flex hinges 122a, 122b gives the load carrying benefits of pinned hinges, without the slop associated with pinned hinges, and provides the appropriate stiffness of the joint 110 in bending.

In the presently preferred embodiment, the base 114 and intermediate layer 116 are made of durable, rigid material, such as plywood or sheet metal, and the cushioning layer is made, e.g., of rubber or foam, to present a cushioning surface on which a user can stand comfortably for extended periods. An exemplary material is the Cumulus Pro anti-fatigue mat, manufactured by Imprint Comfort Mats, available at http://imprintmats.com/content/cumuluspro. The relatively soft material of the cushioning layer 118 can withstand bending along the hinge line 110 without further modification, as is illustrated by the bend lines in FIG. 1B.

The plan view size and shape of the apparatus are such that the apparatus is easily stowed underneath a standard desk chair for storage, such as when a user in a hybrid sit/stand office is sitting in the chair. Referring to FIG. 2, five wheel cutouts 124 are shaped to accommodate the wheels of a standard office chair, and a chair centering guide 126 is shaped to accommodate the hydraulic post protruding from the bottom of the chair. The chair centering guide 126 can either be a through hole extending through the entire platform 102, or may only extend through the top two layers 116 and 118, or through the top layer 118 and partway through the intermediate layer 116. Rolling the chair when the apparatus 100 is stored under it may thus pull and guide the apparatus 100 along the office floor, ensuring it never protrudes beyond the edges of the chair and creates a tripping hazard. A larger size prototype has been built for a user with men's size 16 shoe (US sizing); this prototype is longer in the anteroposterior direction, yet still stows underneath a standard office chair.

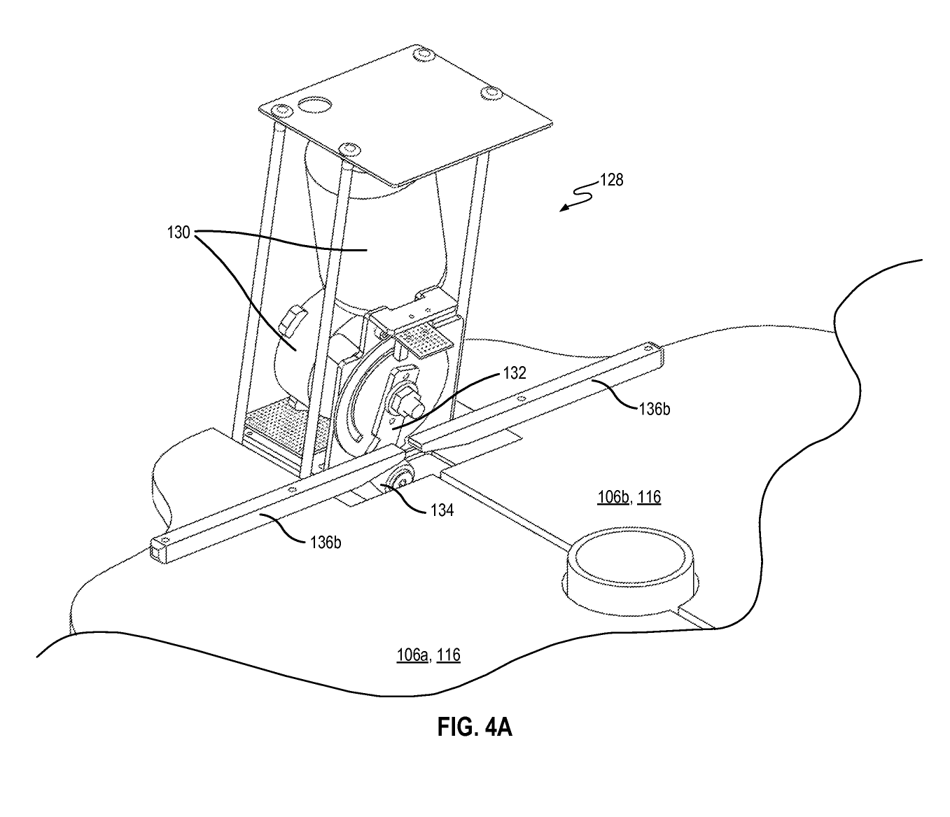

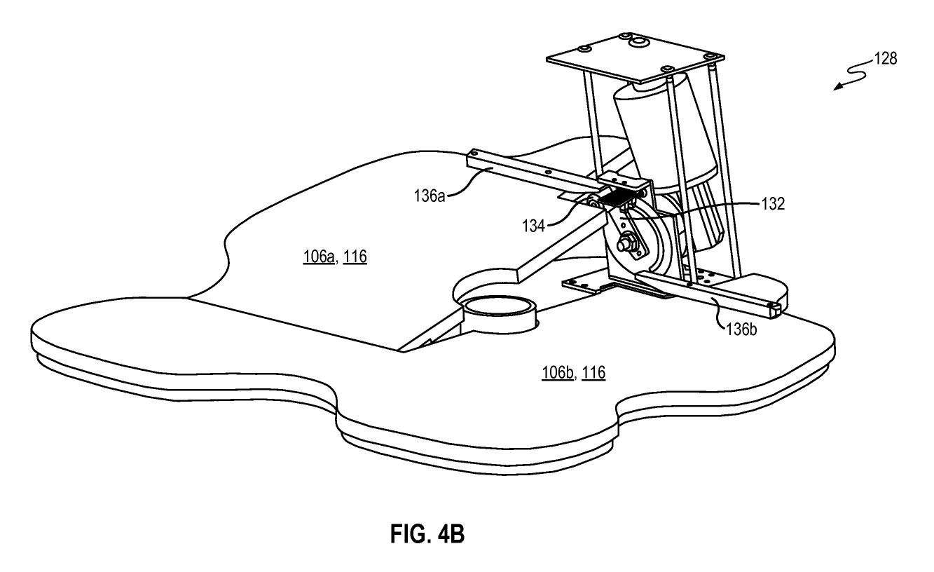

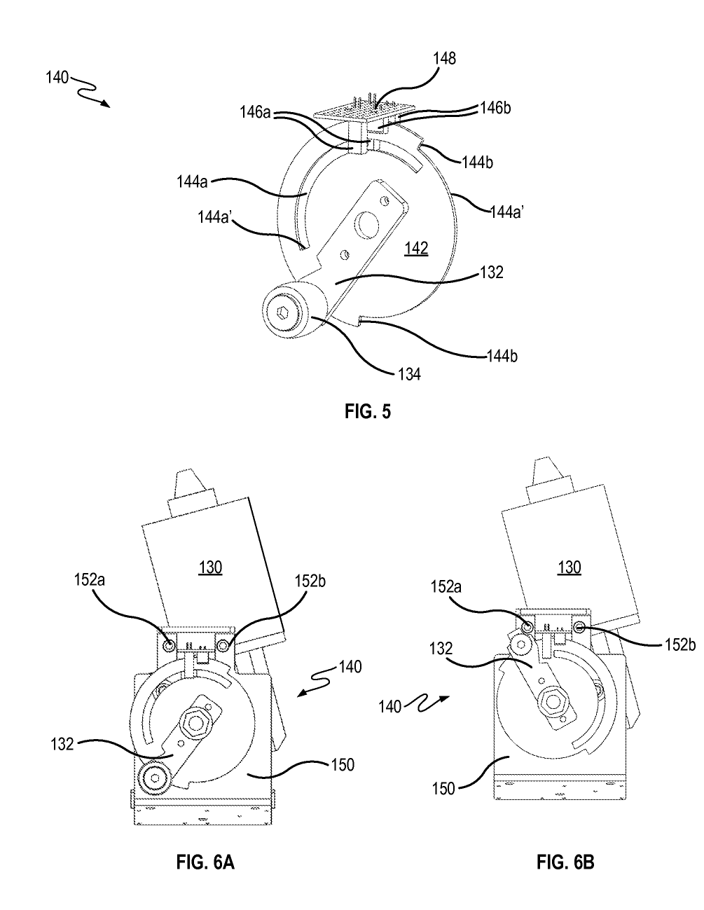

Turning now to FIGS. 4A, 4B, and 5, the operation of lifting and lowering the steps 106a, 106b will now be described.

An actuator 128 includes a right-angle gear motor 130 attached to a lift arm 132, which has a roller 134 at its end. FIGS. 4A and 4B show the apparatus 100 with the cushioning layer 118 removed, and show lift cantilevers 136a, 136b attached to the top of the intermediate layer 116: one lift cantilever 136a, 136b for each step 106a, 106b. The lift cantilevers extend in the medial direction past the medial inner edge of each step 106a, 106b, and extend into the housing 138 (removed for clarity in FIGS. 4A and 4B) of the actuator 128. The lift arm 132 is pivoted by the motor 130 such that the roller 134 engages the underside of the appropriate lift cantilever 136a, 136b at the appropriate time. The lift arm 132 thus raises and lowers the lift cantilever 136a, 136b, and thus the step 106a, 106b, as the motor rotates laterally and medially, respectively.

In other words, when the platform 102 is at the home position of FIGS. 1A and 4A, the lift arm 132 extends straight down, with the roller 134 at the 6:00 position from the frame of reference of a user standing on the platform 102 and facing the actuator 128. To raise the left step 106a, the motor 130 rotates the lift arm 132 laterally clockwise. The roller 134 engages the underside of the lift cantilever 136a and raises the lift cantilever 136a, and thus the left step 106a. To return the left step 106a from the lifted position to the home position, the process is reversed: the motor 130 rotates the lift arm 132 medially counterclockwise. To raise the right step 106b, the motor 130 rotates the lift arm 132 laterally counterclockwise from the 6:00 home position. To return the right step 106b from the lifted position to the home position, the motor 130 rotates the lift arm 132 medially clockwise.

FIG. 5 shows the lift arm 132 and roller 134 in more detail, along with position-sensing hardware 140 which will now be described. The position-sensing hardware includes a position-sensing disk 142 with a left step signaling notch 144a and right step signaling notch 144b. The position-sensing disk is fixedly attached to the lift arm 132, and rotates along with the lift arm 132. The position-sensing hardware further includes a left step optical interrupter 146a and right step optical interrupter 146b, whose positions are fixed, and which do not rotate along with the lift arm 132 and disk 142. The position-sensing hardware further includes a printed circuit board 148, attached to the optical interrupters 146a, 146b.

In FIG. 5, the lift arm 132 and disk 142 are rotated clockwise slightly from the home position, in the early stages of lifting the left step 106a (or the late stages of returning the left step 106a to the home position). As can be seen, in this orientation, the left step optical interrupter 146a has a clear view through the left step signaling notch 144a. The optical interrupter 146a includes a light-emitting device on one side of the disk 142, and a light-receiving device on the other side of the disk 142. As long as the receiving device of the left step optical interrupter 146a can “see” the light-emitting device, the apparatus knows that the left step 106a is in a proper orientation, and is not pivoted up, e.g. more than 14°. When the light of the left step optical interrupter becomes blocked by the edge 144a′ at the bottom left of FIG. 5, the left step is at its fully tilted position, and the apparatus stops rotation of the lift arm 132 and leaves the left step in its fully tilted position for the prescribed period of time, before returning it to the home position.

The right step optical interrupter works in a similar manner, using the notch defined by the right step signaling edges 144b.

When the lift arm 132 is at the home position, both the left step optical interrupter 146a and the right step optical interrupter 146b can “see” through their receiving notches, as seen by the overlap of the notches 144a and 144b near the edges 144a′, 144b near the top right of FIG. 5.

FIG. 6A is an elevation view of the lift arm 132 and position sensing hardware 140, along with the motor 130, and backing plate 150, when the apparatus is in the same configuration as that illustrated in FIG. 5. Also shown in FIG. 6A are two mechanical stops 152a, 152b. In case of software failure, if the lift arm 132 rotates past its clockwise-most position and is not stopped by the optical interrupter 146a, the roller 134 will hit the left step mechanical stop 152a, and the lift arm 132 will be physically blocked from rotating any farther. This configuration, when the lift arm 132 is rotated clockwise just past its clockwise-most intended position and the left step 106a is slightly higher than its topmost intended position, is seen in FIG. 6B; note the roller 134 contacting the mechanical stop 152a.

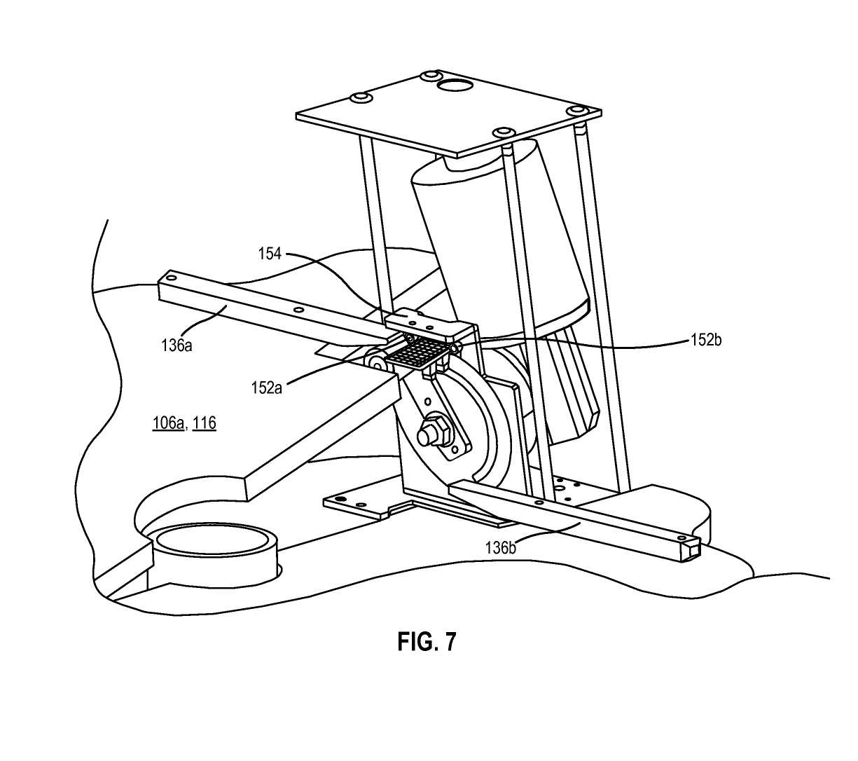

This configuration is also seen in FIG. 7, where the lift cantilever 136a is seen hitting an additional mechanical stop 154. In practice, the cushioning layer 118 (removed from FIG. 7 for clarity) would hit the additional mechanical stop 154 and compress a certain distance before blocking the step 106a from pivoting any farther.

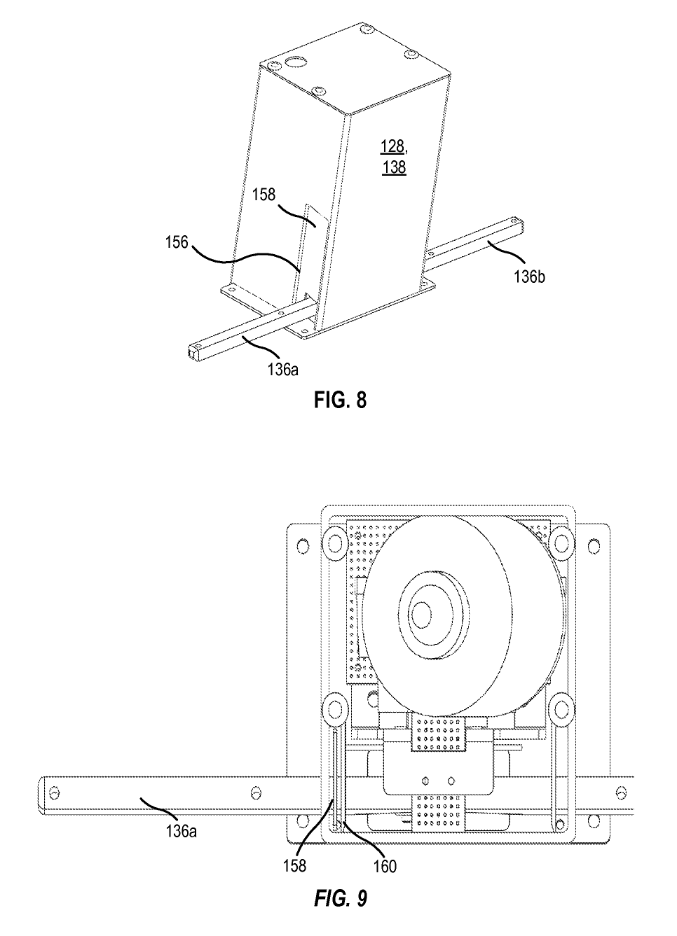

Turning now to FIGS. 8 and 9, the actuator housing 138 defines slots 156 for the vertical movement of the lift cantilevers 136a, 136b (only the left slot 156 is visible). Slot shields 158 are provided within these slots, to prevent debris from entering the housing 138, or pinching of fingers or other body parts. The shields 158 are freely slidable along shield tracks 160, and rest on the lift cantilevers 136a, 136b, sliding in reciprocating movement to the raising and lowering and of the lift cantilevers 136a, 136b.

The steps 106a, 106b and rear region 108 of the “pivoting” embodiment have been shown and described as flat, planar surfaces that are horizontal in the home position. However, the presently claimed invention is not limited to such flat planar surfaces. For example, for various ergonomic and/or comfort-related reasons, it may be desirable for one or more, or all, of the regions 106a, 106b, 108 to deviate substantially from horizontal. For example and without limitation, one or both of the steps 106a, 106b may slope downward laterally, medially, or a combination of laterally and medially at different areas of the step. Additionally or alternatively, one or both of the steps 106a, 106b may slope downward in the forward or rearward direction, or a combination of forward and rearward at different areas of the step. Additionally or alternatively, the rear region 108 may slope downward laterally, medially, or a combination of laterally and medially at different areas of the region. Additionally or alternatively, the rear region 108 may slope downward in the forward or rearward direction, or a combination of forward and rearward at different areas of the region. Additionally or alternatively, one or more of the steps 106a, 106b and region 108 may deviate substantially from planarity, such as, for example and without limitation, by having an arch-support convex region or the like.

Furthermore, as was mentioned above, the user's feet relative to the platform may be rotated 180° from the orientation shown, so that the user's heel region, rather than toe region, is raised and lowered. Changes in size and shape of the first, second, and third regions, and/or any of the above-mentioned deviations from horizontal orientations and/or planarity may be implemented accordingly.

To summarize, in operation, once the apparatus 100 is turned on by the user, it remains in the home position for a certain period of time. The motor 130 rotates the lift arm 132 laterally, lifting up either the left step 106a or the right step 106b at a certain rate of speed, until the corresponding optical interrupter 146a, 146b conveys the information that the step 106a, 106b is at its appropriate raised position, prompting the motor 130 to stop rotating the lift arm 132. After a certain period of time, the lift arm 132 is rotated medially to return to its home position, lowering the step 106a, 106b, and returning the apparatus 100 to the home position. After a certain period of time, the process is then repeated for the other step. If the motor 130 draws under a threshold amount of current for a certain number of these cycles, it is presumed that no weight is resting on the apparatus, and the apparatus automatically shuts off.

Thus, the user is automatically prompted, through tactile feedback, to move his or her feet and shift his or her weight, at intermittent intervals. The user will typically move through several discrete, static positions, each of which keeps him or her within a tight window of interaction with the desk, enabling the user to type, read, write, and manipulate a mouse, in a completely uninterrupted manner, and often without the user noticing the apparatus 100.

As was previously mentioned, in a presently preferred embodiment, each iteration of the home position is held for approximately 90 seconds, each iteration of a step up position is held for approximately 30 seconds, and each step pivots approximately 14 degrees, taking approximately 2 seconds to make the transition from home position to fully tilted, and from fully tilted to home. With these parameters, users in sit/stand hybrid office environments have reported a 167% increase in standing time before becoming fatigued and choosing to sit, and their interactions with keyboards, mice, monitors, and paperwork have not been adversely affected.

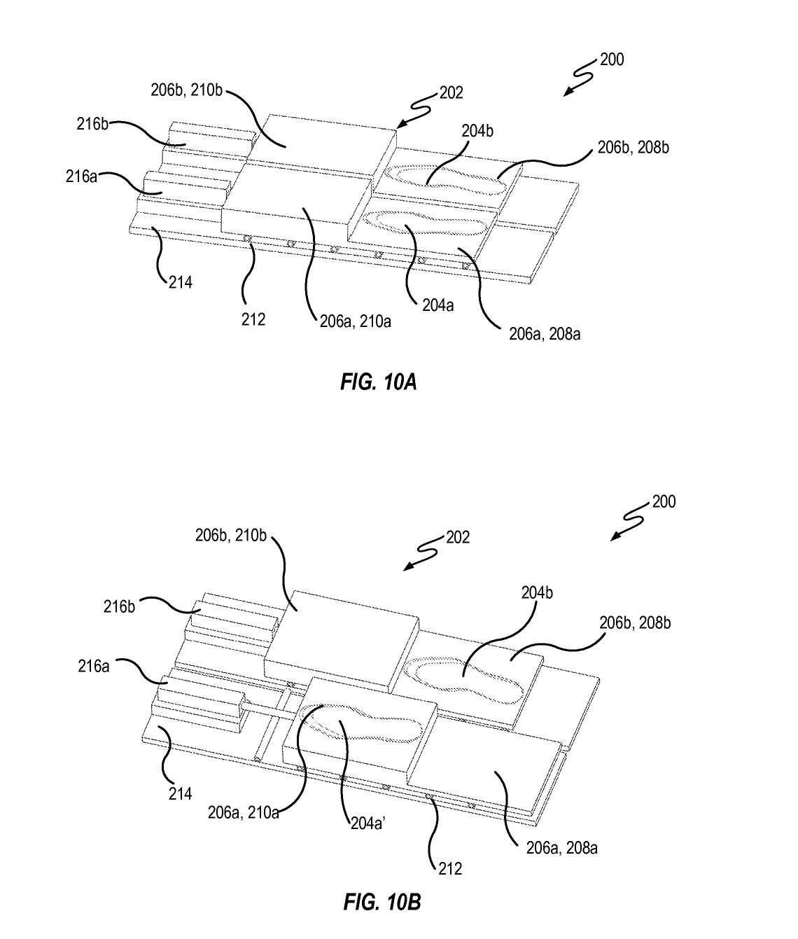

A second exemplary embodiment of an apparatus for preventing fatigue, hereinafter referred to as a “linear” embodiment, or “sliding” embodiment, is illustrated in FIGS. 10A-10B. This embodiment includes a two-part platform 202, with each component being slidable, independent of the other component, as will be described below.

Turning first to FIG. 10A, when the apparatus 200 is in its home position, it presents a two-tiered standing platform 202, on which a user stands, as schematically illustrated by footprints 204a, 204b. (Again, the differently sized footprints indicate different shoe sizes. With the presently preferred dimension of the apparatus, the largest illustrated footprints 204a, 204b indicate a men's size 14 shoe [US sizing].)

The platform includes a left step 206a and a right step 206b. Each step presents both a lower, or “neutral” surface 208a, 208b, and an upper, elevated surface 210a, 210b. The user simply stands on the platform 202 in any comfortable position, such as with both feet on the neutral surfaces 208a, 208b, with his or her weight equally distributed on both feet.

After a set period of time, the apparatus 200 automatically slides the left step 206a backward, as is seen in FIG. 10B. The right step 206b remains in its home position. If the user is standing in a neutral position, as is seen in FIG. 10A, the left foot 204a is automatically slid back. This automatic sliding motion prompts the user to shift his or her weight. Typically, the user will move the left foot forward onto the elevated surface 210b (as is illustrated by the footprint 204a′ in FIG. 10B) and bend the left knee slightly, putting the majority of the user's weight on the right foot.

Alternatively, the user may not choose to move the left foot forward onto the elevated surface 210b, but will instead stand with feet staggered, both on the lower surfaces 208a, 208b, but with the left foot staggered behind the right foot. This stance also prompts a weight shift that prevents fatigue.

After a set period of time, the left step 206a automatically slides forward to the home position seen in FIG. 10A, which may prompt the user to move the left foot back and/or transfer some of his or her weight back to the left foot. After another set period of time, the process is repeated with the right step.

In a presently preferred embodiment, each position (home, left step back, home, right step back, repeat) is held for approximately 30-90 seconds, and each step slides approximately 15 cm, taking approximately 2 seconds to make the transition from home position to fully slid back, and from fully slid back to home. In a presently preferred embodiment, the elevated surfaces 210a, 210b are raised approximately 10 cm from the neutral surfaces 208a, 208b. The claimed invention is not limited to any specific time, distance, or step height, which may vary based on individual needs and/or personal preference. In some embodiments, the time and/or distance may be user-settable. Additionally or alternatively, the time and/or distance may be pre-programmed.

The steps 206a, 206b are slidably mounted, via rollers 212, on a base 214. Each step 206a, 206b is operatively associated with any appropriate linear actuator 216a, 216b, such as an electric cylinder 216a, 216b. The linear actuators 216a, 216b are shown in highly simplified form.

Although not illustrated, the steps 206a, 206b may also be covered with a cushioning layer, similar to that 118 of the first embodiment.

The surfaces 208a, 208b, 210a, 210b of the “sliding” embodiment have been shown and described as flat, planar, horizontal surfaces. However, the presently claimed invention is not limited to such flat planar horizontal surfaces. For example, for various ergonomic and/or comfort-related reasons, it may be desirable for one or more, or all, of the surfaces 208a, 208b, 210a, 210b to deviate substantially from horizontal. For example and without limitation, one, two, three, or all four of the surfaces 208a, 208b, 210a, 210b may slope downward laterally, medially, or a combination of laterally and medially at different areas of the surface. Additionally or alternatively, one, two, three, or all four of the surfaces 208a, 208b, 210a, 210b may slope downward in the forward or rearward direction, or a combination of forward and rearward at different areas of the surface. Additionally or alternatively, one, two, three, or all four of the surfaces 208a, 208b, 210a, 210b may deviate substantially from planarity, such as, for example and without limitation, by having an arch-support convex region or the like.

Thus, the user is automatically prompted, through tactile feedback, to move his or her feet and shift his or her weight, at intermittent intervals. The user will typically move through several discrete, static positions, each of which keeps him or her within a tight window of interaction with the desk, enabling the user to type, read, write, and manipulate a mouse, in a completely uninterrupted manner, and often without the user noticing the apparatus 200.

As was previously mentioned, in a presently preferred embodiment, each position (home, left step back, home, right step back, repeat) is held for approximately 30-90 seconds, and each step slides approximately 15 cm, taking approximately 2 seconds to make the transition from home position to fully slid, and from fully slid to home. The step height is approximately 10 cm. While the inventors have less data for the “sliding” embodiment than for the “pivoting” embodiment, with these parameters, users in sit/stand hybrid office environments have subjectively reported increases in standing time before becoming fatigued and choosing to sit, and their interactions with keyboards, mice, monitors, and paperwork have not been adversely affected.

A third, unillustrated exemplary embodiment of an apparatus for preventing fatigue provides a two-dimensional array of extendable linear elements, which generates a ground surface that can be deformed by the extension/retraction of one or more of the linear elements. Each element can have its own actuator. Alternatively, an X-Y stage can be used to move a single actuator to engage with multiple extendable linear elements to reduce part count and cost.

Other exemplary embodiments are illustrated and described in Appendices A and B, which include sketches and descriptions created by the inventors. These appendices constitute a part of this disclosure and are hereby incorporated by reference herein.

The first, second, and third embodiments, and many of the embodiments disclosed in Appendices A and B, are generally directed to apparatuses and methods that utilize platforms intended for use by standing users confined to limited areas. However, the present disclosure is not limited to this concept.

It will be appreciated from the foregoing that the present inventors believe that moving through many good positions is better than remaining still at one ideal position, particularly when substantially stationary. The present inventors thus have an overall goal of actively encouraging and promoting the natural movements of fidgeting and weight transfer. The inventors' test data show reduced fatigue when using the aforementioned exemplary devices; these data thus suggest that humans lack the subconscious wiring to initiate the remedies of fidgeting and weight transfer proactively with sufficient frequency. This supports the theory that external stimuli and/or reminders are beneficial.

The present inventors have conceived of dozens of other methods and apparatuses that may achieve this same goal and fit in to the underlying philosophy. Some of these methods and apparatuses are directly, indirectly, or tangentially related to the two main exemplary embodiments described in detail above, but the inventors' overall philosophy is not limited to standing users or even to users in office or other work environments.

In a general sense, in one aspect, the inventors have conceived of a method of preventing fatigue by prompting a user, particularly (but not exclusively) a user confined to a limited area, to take self-directed movements, such as through a discrete number of static positions. Additionally or alternatively, a method of preventing fatigue may physically or forcibly move a body part of a passive user, such as by moving him or her through a discrete number of static positions. Additionally or alternatively, a method of preventing fatigue may move a user, or prompt a user to move him- or herself, through a sequence of positions, where the positions generate a distribution around the ergonomic optimum position for the activity.

Some specific products the inventors have conceived of are:

Keyboard or mouse tray, or keyboard or mouse itself: height, distance from user, and/or angle adjusts automatically.

Desk: height, distance from user, and/or angle adjust automatically (for keyboard/mouse support and/or for paperwork review and hand writing).

Split keyboard: angle of split adjusts automatically.

Computer monitor: automatic adjustment of monitor height and/or distance from the user to prevent neck and/or eye fatigue, utilizing digital and/or mechanical means to adjust the offset distance and/or height.

Office chair, car seat, or other seat: any adjustments to sitting position. Automatic adjustments to position, height, tilt of seat, tilt of backrest, shape and/or hardness of seat and/or backrest (e.g. intermittent gluteal and/or lumbar support with varying shapes and/or hardnesses) at regular or sporadic intervals for the purpose of delaying the onset of, or completely preventing, fatigue of the user caused by maintaining a single static posture.

Adjustments to positions or orientations of vehicular pedals or steering wheel.

Seat of a bicycle or other velocipede (e.g. tricycle, unicycle): adjustments to height, forward and backward movement, and/or forward and backward tilt.

Adjustments to positions or orientations of handlebars or pedals of a velocipede.

Encouraging a user to make a large movement to a different overall pose or configuration (e.g., sitting to standing desk, or sitting chair to kneeling chair). This may be done through a tactile cue such as generation of a small oscillatory or vibratory motion in a surface that is physically engaged with the user's body (e.g., chair seat, keyboard, computer mouse, floor, standing mat, or standing platform such as the exemplary standing platforms described herein) and/or a visual or auditory cue, such as from a computer display, office phone, mobile phone, computer speaker, overhead lamp, or desk lamp.

Algorithm for computing reminder intervals for when to encourage a person to make a large movement to a different overall pose or configuration (e.g., sitting to standing desk, or sitting chair to kneeling chair). The algorithm generates reminder behavior using any appropriate method (e.g., the method of the preceding paragraph). The success or effectiveness of the reminder is monitored, such as by using sensors to observe the user take the suggested action, or by the user acknowledging his or her desire or compliance to take the action (e.g., pressing a button to raise his or her desk to a standing height). Based on the success rate, the algorithm adaptively selects the reminder interval to achieve a targeted success rate that encourages the desired behavior with a frequency this is not annoying or off-putting to the specific user. Additional/alternative implementation: based on the success rate and the time of day (or hours worked thus far) the algorithm generates a time-of-day specific reminder interval. For example, as the algorithm converges, reminders may occur more often (or even exclusively) in the morning if they are only effective in the morning.

A surface or platform supported by actively actuatable elements (e.g., mechanical linkage or pneumatic cylinders or chambers) that can be controlled to cause large changes in the shape and or contour or the surface or platform for the purpose of delaying the onset of, or completely preventing, fatigue of the user. As a simple example, a user stands on a deformable platform supported by two pneumatic cylinders with one foot above each cylinder. The cylinders are actuated independently, thus modifying the shape of the platform. Any number of cylinders may be used.

A surface or platform supported by interconnected actuatable elements, which may be, but are not limited to passive elements, whereby the aspects of the interconnect are selectively activated and deactivated (e.g., using a mechanical brake or pneumatic relays) to allow small variations in the user's standing weight distribution to cause large changes in the shape and/or contour of the surface or platform for the purpose of delaying the onset of, or completely preventing, fatigue of the user. In a neutral or “home” position, the cylinders are at mid-travel and are connected together with a pneumatic relay. If the user shifts more weight to the right foot, by opening the relay, the right foot is lowered and the left foot is lifted. The relay can then be closed and the surface can remain in this new orientation until the next change is desired. This can also schematically be imagined as a small teeter-totter with one foot on each end. A mechanical brake is provided at the pivot point, and the braking action is modulated to cause small variations in the user's standing weight distribution to cause large changes in the shape and/or orientation of the surface being stood upon.

Any one or more, or all, of the above and below features and embodiments may be used in any combination or subcombination insofar as they are usable together. For example, a platform may be provided whose steps both pivot, as in the “pivoting” embodiment, and slide, as in the “sliding” embodiment. Any one or more, or all, of the features of any of the alternative embodiments disclosed in appendices A and B may also be utilized together with any one or more, or all, of the features of the pivoting and/or sliding embodiments.

The following enumerated paragraphs represent illustrative, non-exclusive ways of describing inventions according to the present disclosure.

A An apparatus (100), comprising:

a platform (102), comprising:
a first platform region (106a) comprising a first substantially planar surface; and
a second platform region (106b) comprising a second substantially planar surface; and

an actuator (128), wherein the actuator is operatively coupled with the first platform region and with the second platform region;

wherein the actuator is configured to move the apparatus between:
a first state (FIG. 1A) at which the first surface defines a first, substantially horizontal orientation, and the second surface defines a second, substantially horizontal orientation, wherein, in the first state, the first and second surfaces are substantially co-planar; and
a second state (FIG. 1B) at which the first surface defines a third, non-horizontal orientation, and the second surface defines the second orientation.
   A0 The apparatus of paragraph A, wherein the actuator is configured to move the apparatus between the first state, the second state, and a third state at which the first surface defines the first orientation and the second surface defines a fourth, non-horizontal orientation.
   AA An apparatus (100), comprising:

a platform (102), comprising:
a first platform region (106a) comprising a first surface; and
a second platform region (106b) comprising a second surface; and

an actuator (128), wherein the actuator is operatively coupled with the first platform region and with the second platform region;

wherein the actuator is configured to move the apparatus between:
a first state (FIG. 1A) at which the first surface defines a first orientation, and the second surface defines a second orientation, wherein, in the first state, the first and second orientations are substantially symmetric and the first and second surfaces are substantially at the same height as one another; and
a second state (FIG. 1B) at which the first surface defines a third orientation, and the second surface defines the second orientation, wherein the third orientation is not symmetric with the second orientation.
   AA0 The apparatus of paragraph AA, wherein the actuator is configured to move the apparatus between the first state, the second state, and a third state at which the first surface defines the first orientation and the second surface defines a fourth orientation, wherein the fourth orientation is not symmetric with the first orientation.
   AA1 The apparatus of any of claims AA-AA0, wherein the first surface and the second surface are each substantially planar.
   AA2 The apparatus of claim AA, wherein at least one of the first surface and the second surface differs substantially from planarity.
   AA3 The apparatus of any of claims AA-AA2, wherein the first and the second orientations are each substantially horizontal.
   AA4 The apparatus of any of claims AA-AA2, wherein at least one of the first orientation and the second orientation differs substantially from horizontal.
   A1 The apparatus of any of paragraphs A-AA4, wherein the first platform region is a first step (106a) configured and dimensioned for at least a portion of a first foot (104a) of a user to rest thereon, and wherein the second platform region is a second step (106b) configured and dimensioned for at least a portion of a second foot (104b) of the user to rest thereon.
   A1.1 The apparatus of any of paragraphs A-A1, wherein the first platform region is a first step configured and dimensioned for an entirety of a first foot of a user to rest thereon, and wherein the second platform region is a second step configured and dimensioned for an entirety of a second foot of the user to rest thereon.
   A1.2 The apparatus of any of paragraphs A-A1.1, wherein the first platform region is a first step configured and dimensioned for an entirety of a first foot of a user to rest thereon, and wherein the second platform region is a second step configured and dimensioned for an entirety of a second foot of the user to rest thereon, wherein each of the first and second steps is dimensioned to accommodate at least a size 14 men's shoe (US sizing).
   A2 The apparatus of any of paragraphs A-A1.2, wherein the platform further comprises a third platform region (108), wherein the first platform region is hingedly connected to the third platform region, and wherein the second platform region is hingedly connected to the third platform region.
   A3 The apparatus of any of paragraphs A-A2, wherein the third platform region is configured to remain substantially stationary at a fifth orientation, in the first state, the second state, and the third state.
   A4 The apparatus of any of paragraphs A-A3, wherein the fifth orientation is substantially horizontal and substantially co-planar with the first orientation and the second orientation.
   A5 The apparatus of any of paragraphs A-A4, wherein the apparatus is configured and dimensioned to be stowed underneath a standard office chair.
   A6 The apparatus of any of paragraphs A-A5, wherein the platform comprises cut-outs configured and dimensioned to accommodate the wheels of the office chair.
   A7 The apparatus of any of paragraphs A-A6, wherein the platform comprises a depression or a hole configured and dimensioned to accommodate the central hydraulic post at the bottom of the office chair.
   A8 The apparatus of any of paragraphs A-A7, wherein the actuator is exactly one actuator.
   A9 The apparatus of any of paragraphs A-A8, wherein the actuator comprises an arm that is configured to pivot to thereby lift the first platform region from the first orientation to the third orientation and/or to lift the second platform region from the second orientation to the fourth orientation.
   A10 The apparatus of any of paragraphs A-A9, wherein the motion between the first state, the second state, and optionally the third state prompts the user to move at least one foot and/or shift the user's weight.
   B An apparatus (200), comprising:

a platform (202), comprising:
a first platform region (206a) comprising a first substantially planar surface (208a) and a second substantially planar surface (210a); and
a second platform region (206b) comprising a third substantially planar surface (208b) and a fourth substantially planar surface (210b);
   wherein the first platform region and the second platform region are adjacent one another along medial regions thereof;
   wherein the first surface (208a) and the third surface (208b) are substantially co-planar;
   wherein the second surface (210a) is not co-planar with the first and third surfaces (208a, 208b);
   and wherein the fourth surface (210b) is not co-planar with the first and third surfaces (208a, 208b); and
at least one actuator (216a, 216b), wherein the actuator is operatively coupled with the first platform region and with the second platform region;

wherein the actuator is configured to move the apparatus between:
a first state (FIG. 10A) at which the first surface (208a) and the third surface (208b) are adjacent one another along medial regions thereof; and
a second state (FIG. 10B) at which at least a portion of the second surface (210a) is adjacent the third surface (208b), to thereby define a first discontinuity between the medial regions of the first platform region and the second platform region.
   B0 The apparatus of paragraph B, wherein the actuator is configured to move the apparatus between the first state, the second state, and a third state at which at least a portion of the fourth surface (210b) is adjacent the first surface (208a), to thereby define a second discontinuity between the medial regions of the first platform region and the second platform region.
   BB An apparatus (200), comprising:

a platform (202), comprising:
a first platform region (206a) comprising a first surface (208a) and a second surface (210a); and
a second platform region (206b) comprising a third surface (208b) and a fourth surface (210b);
   wherein the first platform region and the second platform region are adjacent one another along medial regions thereof;
   wherein the first surface (208a) and the third surface (208b) are substantially symmetric and substantially at the same height as one another and;
   wherein the second surface (210a) is not symmetric with the third surface (208b);
   and wherein the fourth surface (210b) is not symmetric with the first surface (208a); and
at least one actuator (216a, 216b), wherein the actuator is operatively coupled with the first platform region and with the second platform region;

wherein the actuator is configured to move the apparatus between:
a first state (FIG. 10A) at which the first surface (208a) and the third surface (208b) are adjacent one another along medial regions thereof; and
a second state (FIG. 10B) at which at least a portion of the second surface (210a) is adjacent the third surface (208b), to thereby define a first discontinuity between the medial regions of the first platform region and the second platform region.
   BB0 The apparatus of paragraph BB, wherein the actuator is configured to move the apparatus between the first state, the second state, and a third state at which at least a portion of the fourth surface (210b) is adjacent the first surface (208a), to thereby define a second discontinuity between the medial regions of the first platform region and the second platform region.
   BB1 The apparatus of any of claims BB-BB0, wherein the first surface, the second surface, the third surface, and the fourth surface are each substantially planar.
   BB2 The apparatus of any of claims BB-BB0, wherein at least one of the first surface, the second surface, the third surface, and the fourth surface differs substantially from planarity.
   BB3 The apparatus of any of claims BB-BB2, wherein the first surface, the second surface, the third surface, and the fourth surface are each substantially horizontal.
   BB4 The apparatus of any of claims BB-BB2, wherein at least one of the first surface, the second surface, the third surface, and the fourth surface differs substantially from horizontal.
   B1 The apparatus of any of paragraphs B-BB4, wherein the first and third surfaces are substantially parallel to the second and fourth surfaces.
   B1.1. The apparatus of any of paragraphs B-B1, wherein the second and fourth surfaces are substantially co-planar.
   B2 The apparatus of any of paragraphs B-B1.1, wherein the first surface (208a) and the second surface (210a) are each configured and dimensioned for at least a portion of a first foot (204a) of a user to rest thereon, and wherein the third surface (208b) and the fourth surface (210b) are each configured and dimensioned for at least a portion of a second foot (204b) of the user to rest thereon.
   B3 The apparatus of any of paragraphs B-B2, wherein the first surface (208a) and the second surface (210a) are each configured and dimensioned for an entirety of a first foot of a user to rest thereon, and wherein the third surface (208b) and the fourth surface (210b) are each configured and dimensioned for an entirety of a second foot of the user to rest thereon, wherein each of the first, second, third, and fourth surfaces is dimensioned to accommodate at least a size 14 men's shoe (US sizing).
   B4 The apparatus of any of paragraphs B-B3, wherein the at least one actuator comprises two actuators (216a, 216b), wherein a first one of the actuators (216a) is operatively associated with the first platform region (206a), and a second one of the actuators (216b) is operatively associated with the second platform region (206b).
   B5 The apparatus of any of paragraphs B-B4, wherein the motion between the first, second, and optionally third states comprises sliding one or both platform regions in a direction generally transverse to the medial direction.
   B6 The apparatus of any of paragraphs B-B5, wherein each of the first and the second actuators is a linear actuator.
   B7 The apparatus of any of paragraphs B-B6, wherein the motion between the first state, the second state, and optionally the third state prompts the user to move at least one foot and/or shift the user's weight.
   B8 The apparatus of any of paragraphs B-B7, wherein the motion between the first state, the second state, and optionally the third state prompts the user to move the first foot between the first surface (208a) and the second surface (210a), and/or to move the second foot between the third surface (208b) and the fourth surface (210b).
   B8.1 The apparatus of any of paragraphs B-B7, wherein the motion between the first state, the second state, and optionally the third state allows the user to leave the first foot on the first surface (208a) and leave the second foot on the third surface (208b) to thereby define a staggered stance with the first and the second foot substantially co-planar and staggered in an anteroposterior direction.
   B9 The apparatus of any of paragraphs B-B8, including the subject matter of any of paragraphs A-A 10.
   C An apparatus (100, 200), comprising:

a platform (102, 202), configured and dimensioned for a user to stand on the platform, wherein the platform comprises:
a first step (106a, 206a) configured and dimensioned for at least a portion of a first foot (104a, 204a, 204a′) of the user to rest on the first step; and
a second step (106b, 206b) configured and dimensioned for at least a portion of a second foot (104b, 204b) of the user to rest on the second step;

wherein the platform is movable between:
a first state (FIG. 1A, FIG. 10A), at which:
   the first step presents a first substantially horizontal, planar surface (106a, 208a) to the user, such that the user's first foot (104a, 204a) rests on the first surface; and
   the second step presents a second substantially horizontal, planar surface (106b, 208b) to the user, such that the user's second foot (104b, 204b) rests on the second surface;
   wherein the first and second surfaces are substantially co-planar; and
a second state (FIG. 1B, FIG. 10B), at which:
   the second step presents the second substantially horizontal, planar surface (106b, 208b) to the user, such that the user's second foot (104b, 204b) rests on the second surface; and
   the first step presents a third surface (106a, 210a) to the user, such that the user's first foot (104a, 204a′) rests on the third surface, wherein the third surface deviates substantially from co-planarity with the second surface; and

at least one actuator (128; 216a, 216b), operatively coupled with the platform, and configured to move the platform between the first and second states.

C0 The apparatus of paragraph C, wherein the actuator is configured to move the apparatus between the first state, the second state, and a third state at which:

the first step presents the first substantially horizontal, planar surface (106a, 208a) to the user, such that the user's first foot (104a, 204a) rests on the first surface; and

the second step presents a fourth surface (106b, 210b) to the user, such that the user's second foot (104b, 204b) rests on the fourth surface, wherein the fourth surface deviates substantially from co-planarity with the first surface.

CC An apparatus (100, 200), comprising:

a platform (102, 202), configured and dimensioned for a user to stand on the platform, wherein the platform comprises:
a first step (106a, 206a) configured and dimensioned for at least a portion of a first foot (104a, 204a, 204a′) of the user to rest on the first step; and
a second step (106b, 206b) configured and dimensioned for at least a portion of a second foot (104b, 204b) of the user to rest on the second step;

wherein the platform is movable between:
a first state (FIG. 1A, FIG. 10A), at which:
   the first step presents a first surface (106a, 208a) to the user, such that the user's first foot (104a, 204a) rests on the first surface; and
   the second step presents a second surface (106b, 208b) to the user, such that the user's second foot (104b, 204b) rests on the second surface;
   wherein the first and second surfaces are substantially symmetric and substantially at the same height as one another; and
a second state (FIG. 1B, FIG. 10B), at which:
   the second step presents the second surface (106b, 208b) to the user, such that the user's second foot (104b, 204b) rests on the second surface; and
   the first step presents a third surface (106a, 210a) to the user, such that the user's first foot (104a, 204a′) rests on the third surface, wherein the third surface is not symmetric with the second surface; and

at least one actuator (128; 216a, 216b), operatively coupled with the platform, and configured to move the platform between the first and second states.

CC0 The apparatus of paragraph CC, wherein the actuator is configured to move the apparatus between the first state, the second state, and a third state at which:

the first step presents the first surface (106a, 208a) to the user, such that the user's first foot (104a, 204a) rests on the first surface; and

the second step presents a fourth surface (106b, 210b) to the user, such that the user's second foot (104b, 204b) rests on the fourth surface, wherein the fourth surface is not symmetric with the first surface.

CC1 The apparatus of any of claims CC-CC0, wherein the first surface, the second surface, the third surface, and the fourth surface are each substantially planar.
CC2 The apparatus of any of claims CC-CC0, wherein at least one of the first surface, the second surface, the third surface, and the fourth surface differs substantially from planarity.
CC3 The apparatus of any of claims CC-CC2, wherein at least the first surface (106a in FIG. 1A; 208a) and the second surface (106b in FIG. 1A; 208b) are each substantially horizontal.
CC3.1 The apparatus of any of claims CC-CC3, wherein the third surface (210a) and the fourth surface (210b) are each substantially horizontal.
CC4 The apparatus of any of claims CC-CC3.1, wherein at least one of the first surface, the second surface, the third surface, and the fourth surface differs substantially from horizontal.
CCC An apparatus, comprising: a means for prompting a user to move at least one body part of the user between at least a first and a second position of the body part, wherein, when the body part is at the first position, the user is in a first pose, and when the body part is at the second position, the user is in a second pose, to thereby prevent the user from maintaining any single pose for a fatigue-inducing duration.
As used herein, the word “pose” should be understood to mean any overall body configuration. Exemplary poses include, but are not limited to, standing, sitting, lying, and kneeling, with limbs, digits, and extremities in any configuration.
CCC0 An apparatus, comprising:

a means for forcibly moving at least one body part of a user between at least a first and a second position of the body part, wherein, when the body part is at the first position, the user is in a first pose, and when the body part is at the second position, the user is in a second pose, to thereby prevent the user from maintaining any single pose for a fatigue-inducing duration.

CCC1 The apparatus of any of claims CCC or CCC0, wherein the means for prompting the user or the means for forcibly moving the body part comprises a movable step.
CCC2 The apparatus of claim CCC1, wherein the step is pivotable and/or slidable.
C1 The apparatus of any of paragraphs A-CCC2, wherein at the first state, the user assumes a first pose at a location, and at the second state, the user assumes a second pose while remaining substantially stationary at the location.
C2 The apparatus of any of paragraphs A-C1, wherein at the third state, the user assumes a third pose while remaining substantially stationary at the location.
C3 The apparatus of any of paragraphs A-C2, wherein the apparatus is configured to:

remain stationary at the first state for a certain period of time, at which the user assumes the first pose, wherein the first pose is substantially static;

move from the first state to the second state to thereby prompt the user to transition from the first pose to the second pose; and

remain stationary at the second state for a certain period of time, at which the user assumes the second pose, wherein the second pose is substantially static and is discrete from the first pose.

C4 The apparatus of any of paragraphs A-C3, wherein the apparatus is further configured to move from the second state to the first state to thereby prompt the user to transition from the second pose to the first pose, and to remain stationary at the first state for a certain period of time, at which the user assumes the first pose.
C5 The apparatus of any of paragraphs A-C4, wherein the apparatus is further configured to move from the first state to the third state to thereby prompt the user to transition from the first pose to the third pose, and to remain stationary at the third state for a certain period of time, at which the user assumes the third pose, wherein the third pose is substantially static and is discrete from the first pose and the second pose.
C6 The apparatus of any of paragraphs A-C5, wherein the apparatus is configured to adopt the first state for a certain period of time, move from the first state to the second state, adopt the second state for a certain period of time, move from the second state to the first state, adopt the first state for a certain period of time, move from the first state to the third state, adopt the third state for a certain period of time, and move from the third state to the first state.
C7 The apparatus of any of paragraphs A-C6, wherein the apparatus is configured to repeat the steps of paragraph C6 until the apparatus is turned off or automatically shuts off
C8 The apparatus of any of paragraphs C-C7, including the subject matter of any of paragraphs A-A 10.
C9 The apparatus of any of paragraphs C-C8, including the subject matter of any of paragraphs B-B9.
D Use of the apparatus of any of paragraphs A-C9.
D1 Use of the apparatus of any of paragraphs A-C9 to prevent fatigue of the user.
D2 Use of the apparatus of any of paragraphs A-C9 wherein each of the first pose, the second pose, and optionally the third pose comprises standing.
D3 Use of the apparatus of any of paragraphs A-C9 in connection with a standing desk.
D4 Use of the apparatus of any of paragraphs A-C9 in connection with a line of employment that requires users to stand for a significant amount of time.
D5 Use of the apparatus of any of paragraphs A-C9 in connection with an office worker using a standing desk, a cashier, a factory worker, a teacher, a lecturer, a cook, a dishwasher, a loboratory employee, a medical professional, or a receptionist.
EA A method of preventing fatigue in a user, comprising:

prompting the user to move at least one body part of the user between at least a first and a second position of the body part, wherein, when the body part is at the first position, the user is in a first pose, and when the body part is at the second position, the user is in a second pose, to thereby prevent the user from maintaining any single pose for a fatigue-inducing duration.

EA1 The method of paragraph EA, wherein the prompting comprises giving a tactile cue.
EA2 The method of any of paragraphs EA-EA1, wherein the prompting comprises subtly forcibly moving the body part from the first position to a third position that is near the first position, wherein the subtle forcible movement acts as a tactile cue to remind the user to move the body part from the third position to the second position.
EA2.1 The method of any of paragraphs EA-EA2, wherein the body part is at least a part of a foot.
EA2.2 The method of any of paragraphs EA-EA2.1, wherein the body part is a forefoot region.
EA2.3 The method of any of paragraphs EA-EA2.1, wherein the body part is a heel region of a foot.
EA3 The method of any of paragraphs EA-EA2.3, wherein, when the body part is at the third position, the user is substantially at the first pose.
EA4 The method of any of paragraphs EA-EA3, wherein the prompting comprises giving a visual cue or an auditory cue.
EB A method of preventing fatigue in a user, comprising:

forcibly moving at least one body part of the user between at least a first and a second position of the body part, wherein, when the body part is at the first position, the user is in a first pose, and when the body part is at the second position, the user is in a second pose, to thereby prevent the user from maintaining any single pose for a fatigue-inducing duration.

EB1 The method of paragraph EB, wherein the user plays a passive role in being moved from the first pose to the second pose.
EC A method of preventing fatigue in a user, comprising:

at least one of:
(a) prompting the user to move at least one body part of the user between a plurality of positions of the body part, and/or
(b) forcibly moving the at least one body part between the plurality of positions of the body part;

wherein the plurality of positions define a distribution around a substantially optimum position.

ED A method of preventing fatigue in a user, comprising:

at least one of:
(a) prompting the user to move at least one body part of the user between a plurality of positions of the body part, and/or
(b) forcibly moving the at least one body part between the plurality of positions of the body part;
wherein each position of the body part defines a pose of the user;

wherein the plurality of poses define a distribution around a substantially optimum pose.

EE A method of preventing fatigue in a user engaged in an activity, wherein the activity requires the user to be confined to a limited area, the method comprising at least one of:

(a) prompting the user to take self-directed movements through a sequence of static poses, and/or

(b) moving the user through the sequence of static poses;

wherein the poses generate a distribution around the ergonomic optimum pose for the activity.

EE1 The method of paragraph EE, wherein the activity comprises at least one member selected from the group consisting of:
working at a desk;
working at a sitting desk;
working at a standing desk;
working in a hybrid sit/stand environment;
using a keyboard;
using a mouse;
working with paperwork;
looking at a monitor or screen;
working at a cash register;
working in a factory;
lecturing at a podium;
lecturing at a chalkboard or whiteboard;
working as a receptionist;
cooking or otherwise preparing food and/or drink;
washing dishes;
working at a lab bench;
working at an exam table;
driving or flying a motorized vehicle;
driving a motorcycle or moped;
riding a velocipede;
being a passenger in or on a motorized vehicle, motorcycle, moped, or velocipede;
commuting;
reading;
resting;
recovering from illness or injury; and
sleeping.
   EF1 The method of any of paragraphs EA-EE1, wherein each of the poses comprises at least one member of the group consisting of standing, sitting, kneeling, and lying down.
   EF2 The method of any of paragraphs EA-EF1, wherein each of the poses comprises standing, and wherein the first pose comprises a first stance and the second pose comprises a second, different stance.
   As used herein, the word “stance” should be understood to be a pose that involves a generally standing configuration, as opposed to sitting, lying, kneeling, or other configurations. Limbs, digits, and extremities may assume any configuration that defines an overall standing configuration of the body as a whole.
   EF3 The method of any of paragraphs EA-EF2 wherein the first stance comprises a substantially neutral stance and wherein the second stance comprises the user placing more weight on a first foot of the user than on a second foot of the user.
   EF4 The method of any of paragraphs EA-EF3, wherein each pose is a discrete, static pose.
   EF5 The method of any of paragraphs EA-EF4, wherein the poses define a distribution around a mean pose.
   EF6 The method of any of paragraphs EA-EF5, wherein the mean pose defines a substantially optimum pose.
   EF7 The method of any of paragraphs EA-EF6, wherein the substantially optimum pose is selected based on a current activity of the user.
   EF8 The method of any of paragraphs EA-EF7, including the subject matter of any of paragraphs A-C9.
   EF9 An apparatus configured to carry out the method of any of paragraphs EA-EF8.
   F Use of the apparatus of paragraph EF9.
   G An apparatus substantially as shown and described.
   G1 A method substantially as shown and described.

As used herein, the terms “adapted” and “configured,” when used to describe an apparatus, element, component, or other subject matter, mean that the apparatus, element, component, or other subject matter is designed and/or intended to perform the recited function. Thus, the use of the terms “adapted” and “configured” should not be construed to mean that a given apparatus, element, component, or other subject matter simply is “capable” of performing the recited function. Rather, the apparatus, element, component, and/or other subject matter is created specifically for the purpose of performing the recited function. It is also within the scope of the present disclosure that apparatuses, elements, components, and/or other subject matter that is recited as being configured to perform a particular function may additionally or alternatively be described as being adapted to perform that function, and vice versa.

As used herein, the term “and/or” placed between a first entity and a second entity means one of (1) the first entity, (2) the second entity, and (3) the first entity and the second entity. Multiple entities listed with “and/or” should be construed in the same manner, i.e. “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

In the event that any of the patent documents that are incorporated by reference herein defines a term in a manner or is otherwise inconsistent with either the non-incorporated disclosure of the present application or with any of the other incorporated references, the non-incorporated disclosure of the present application shall control and the term or terms as used therein only control with respect to the patent document in which the term is defined.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods, and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps. Furthermore, while the disclosure set forth above describes different embodiments and features, these are interchangeable, and parts can be implemented without all aspects of the respective disclosed embodiment, for example, hydraulic drive with pivoting platform, etc.

Inventions embodied in various combinations and subcombinations of features, functions, elements, properties, steps, and/or methods may be claimed through presentation of new claims in a related application. Such new claims, whether they are directed to a different invention or directed to the same invention, whether different, broader, narrower, or equal in scope to the original claims, are also regarded as included within the subject matter of the present disclosure.

The pivoting embodiment prompts a user to move his or her body between at least a first pose and a second pose to thereby prevent the user from maintaining any single pose for a duration long enough to induce fatigue. The prompting may include a tactile cue.

Additionally or alternatively, the prompting may include subtly forcibly moving a body part such as a foot from one position to another position that is near the original position. This subtle forcible movement may act as a tactile cue to remind the user to move the foot even farther to yet another position.

Additionally or alternatively, the pivoting embodiment has the effect of moving a user, or prompting a user to move, through a plurality of poses or positions that may define a distribution around a mean pose which may define a substantially ergonomic optimum pose or position, which may be selected based on a current activity of the user. Each pose or position may be a discrete, static pose.

While treadmill desks are generally known, the “pivoting” embodiment differs from those of a treadmill desk in one or more of the following ways:

The poses may be a plurality of discrete poses, each of which is substantially static.

This is in direct opposition to a treadmill desk, which effects constant continuous movement with no opportunity for the user to pause at a discrete or static pose. Additionally or alternatively, use of the “pivoting” embodiment leads to the overall effect of fatigue prevention in a user. This is in direct opposition to a treadmill desk, whose overall effect is to provide exercise, i.e. to create fatigue.

This may be due, at least in part, to the overall configuration of the “pivoting” embodiment. Additionally or alternatively, the “pivoting” embodiment may be programmed to move at a speed and/or with a frequency that leads to the fatigue-reduction effects.

The sliding embodiment moves a user, and/or prompts a user to move his or her body, between at least a first pose and a second pose to thereby prevent the user from maintaining any single pose for a duration long enough to induce fatigue.

The user may be prompted to move, such as through a tactile cue. Additionally or alternatively, the prompting may include subtly forcibly moving a body part such as a foot from one position to another position that is near the original position. This subtle forcible movement may act as a tactile cue to remind the user to move the foot even farther to yet another position.

Additionally or alternatively, the user may choose not to move his or her foot from the lower surface to the upper surface when the sliding embodiment slides his or her foot back, but instead may choose to stand on a single level with a staggered stance. Under these conditions, the sliding embodiment may have the technical effect of forcibly moving the user between at least a first pose and a second pose to thereby prevent the user from maintaining any single pose for a duration long enough to induce fatigue. The user may play a passive role in being moved from the first pose to the second pose.

Additionally or alternatively, the sliding embodiment has the effect of moving a user, or prompting a user to move, through a plurality of poses or positions that may define a distribution around a mean pose which may define a substantially ergonomic optimum pose or position, which may be selected based on a current activity of the user. Each pose or position may be a discrete, static pose.

Again, while treadmill desks are generally known, the “sliding” embodiment differs from those of a treadmill desk in one or more of the following ways:

The poses may be a plurality of discrete poses, each of which is substantially static.

This is in direct opposition to a treadmill desk, which effects constant continuous movement with no opportunity for the user to pause at a discrete or static pose.

Additionally or alternatively, use of the “sliding” embodiment leads to the overall effect of fatigue prevention in a user. This is in direct opposition to a treadmill desk, whose overall effect is to provide exercise, i.e. to create fatigue.

This may be due, at least in part, to the overall configuration of the “sliding” embodiment. Additionally or alternatively, the “sliding” embodiment may be programmed to move at a speed and/or with a frequency that leads to the fatigue-reduction effects.

What is claimed is:

1. An apparatus, comprising:
a platform, comprising:
a first platform region comprising a first surface; and
a second platform region comprising a second surface; and
an actuator, wherein the actuator is operatively coupled with the first platform region and with the second platform region;
wherein the actuator is configured to move the apparatus between:
a first state at which the first surface defines a first orientation, and the second surface defines a second orientation, wherein, in the first state, the first and second orientations are substantially symmetric and the first and second surfaces are substantially at the same height as one another; and
a second state at which the first surface defines a third orientation, and the second surface defines the second orientation, wherein the third orientation is not symmetric with the second orientation.

2. The apparatus of claim 1, wherein the actuator is configured to move the apparatus between the first state, the second state, and a third state at which the first surface defines the first orientation and the second surface defines a fourth orientation, wherein the fourth orientation is not symmetric with the first orientation.

3. The apparatus of claim 1, wherein the first surface and the second surface are each substantially planar.

4. The apparatus of claim 1, wherein at least one of the first surface and the second surface differs substantially from planarity.

5. The apparatus of claim 1, wherein the first and the second orientations are each substantially horizontal.

6. The apparatus of claim 1, wherein at least one of the first orientation and the second orientation differs substantially from horizontal.

7. The apparatus of claim 1, wherein the first platform region is a first step configured and dimensioned for at least a portion of a first foot of a user to rest thereon, and wherein the second platform region is a second step configured and dimensioned for at least a portion of a second foot of the user to rest thereon.

8. The apparatus of claim 1, wherein the first platform region is a first step configured and dimensioned for an entirety of a first foot of a user to rest thereon, and wherein the second platform region is a second step configured and dimensioned for an entirety of a second foot of the user to rest thereon.

9. The apparatus of claim 1, wherein the platform further comprises a third platform region, wherein the first platform region is hingedly connected to the third platform region, and wherein the second platform region is hingedly connected to the third platform region.

10. The apparatus of claim 9, wherein the third platform region is configured to remain substantially stationary at a fifth orientation, in the first state and the second state.

11. The apparatus of claim 10, wherein the fifth orientation is substantially horizontal and substantially co-planar with the first orientation and the second orientation.

12. The apparatus of claim 1, wherein the apparatus is configured and dimensioned to be stowed underneath a standard office chair.

13. The apparatus of claim 1, wherein the actuator is exactly one actuator.

14. The apparatus of claim 2, wherein the actuator comprises an arm that is configured to pivot to thereby lift the first platform region from the first orientation to the third orientation and to lift the second platform region from the second orientation to the fourth orientation.

15. The apparatus of claim 1, wherein the motion between the first state and the second state prompts the user to take at least one of the following actions:
to move at least one foot; and
to shift the user's weight.

16. An apparatus, comprising:
a platform, comprising:
a first platform region comprising a first surface and a second surface; and
a second platform region comprising a third surface and a fourth surface;
wherein the first platform region and the second platform region are adjacent one another along medial regions thereof;
wherein the first surface and the third surface are substantially symmetric and substantially at the same height as one another and;
wherein the second surface is not symmetric with the third surface;
and wherein the fourth surface is not symmetric with the first surface; and
at least one actuator, wherein the actuator is operatively coupled with the first platform region and with the second platform region;
wherein the actuator is configured to move the apparatus between:
a first state at which the first surface and the third surface are adjacent one another along medial regions thereof; and
a second state at which at least a portion of the second surface is adjacent the third surface, to thereby define a first discontinuity between the medial regions of the first platform region and the second platform region.

17. The apparatus of claim 16, wherein the actuator is configured to move the apparatus between the first state, the second state, and a third state at which at least a portion of the fourth surface is adjacent the first surface, to thereby define a second discontinuity between the medial regions of the first platform region and the second platform region.

18. The apparatus of claim 16, wherein the first surface, the second surface, the third surface, and the fourth surface are each substantially planar.

19. The apparatus of claim 16, wherein at least one of the first surface, the second surface, the third surface, and the fourth surface differs substantially from planarity.

20. An apparatus, comprising:
a platform, configured and dimensioned for a user to stand on the platform, wherein the platform comprises:
a first step configured and dimensioned for at least a portion of a first foot of the user to rest on the first step; and
a second step configured and dimensioned for at least a portion of a second foot of the user to rest on the second step;
wherein the platform is movable between:
a first state, at which:
the first step presents a first surface to the user, such that the user's first foot rests on the first surface; and
the second step presents a second surface to the user, such that the user's second foot rests on the second surface;
wherein the first and second surfaces are substantially symmetric and substantially at the same height as one another; and
a second state, at which:
the second step presents the second surface to the user, such that the user's second foot rests on the second surface; and
the first step presents a third surface to the user, such that the user's first foot rests on the third surface, wherein the third surface is not symmetric with the second surface; and
at least one actuator, operatively coupled with the platform, and configured to move the platform between the first and second states.
